(19) United States
(12) Patent Application Publication
(10) Pub. No.: US 2025/0052904 A1
(43) Pub. Date: Feb. 13, 2025

(54) Enhanced optical scanning module and device

(71) Applicant: Teknologian tutkimuskeskus VTT Oy, Espoo (FI)

(72) Inventors: Jussi Tenhunen, Espoo (FI); Kai Ojala, Espoo (FI); Markku Alamäki, Espoo (FI); Sanna Uusitalo, Espoo (FI)

(21) Appl. No.: 18/721,891

(22) PCT Filed: Dec. 15, 2022
(86) PCT No.: PCT/FI2022/050841

§ 371 Date: Jun. 20, 2024

(30) Foreign Application Priority Data
Dec. 22, 2021 (FI) 20216323

(51) Int. Cl. G01S 17/931; G01S 7/481; G02B 26/08; G02B 26/10

(52) U.S. Cl. CPC G01S 17/931; G01S 7/4817; G02B 26/0858; G02B 26/105

(57) ABSTRACT

According to an example aspect of the present invention, there is provided an optical scanning module, comprising a scanning mirror, wherein the scanning mirror is arranged to direct a first light signal coming from a single light source to a first telescope objective via a first optical path, and at least one second light signal coming from the single light source to at least one second optical path, to scan at different distances with different angular resolutions, wherein the first optical path is different than the second optical path, and the optical scanning module is arranged to receive a reflected version of the first light signal via the first telescope objective and the first optical path, and a reflected version of the at least one second light signal via the at least one second optical path.

### FIELD

Embodiments of the present invention relate in general to an enhanced optical scanning module and device.

### BACKGROUND

In many applications of optical scanning, the need for angular resolution and measurement range depends on angular scan coordinates. For example, in a moving vehicle, such as an autonomous car, it would be beneficial to scan at long distance with high angular resolution in the direction of the movement. On the other hand, on sides of the moving vehicle, lower maximum distance and lower angular resolution may be sufficient while wider scanning field may be beneficial on the sides. Scanning modules and devices, which scan both, long range and wide field, at the same time may be too large for practical applications. Such modules and devices may be too expensive for mass production as well. There is therefore a need to provide an enhanced optical scanning module and device.

### SUMMARY OF THE INVENTION

According to some aspects, there is provided the subject-matter of the independent claims. Some embodiments are defined in the dependent claims.

According to a first aspect of the present invention, there is provided an optical scanning module, comprising a scanning mirror, wherein the scanning mirror is arranged to direct a first light signal coming from a single light source to a first telescope objective via a first optical path, and at least one second light signal coming from the single light source to at least one second path, to scan at different distances with different angular resolutions, wherein the first optical path is different than the second optical path, and the optical scanning module is arranged to receive a reflected version of the first light signal via the first telescope objective and a reflected version of the at least one second light signal via the at least one second optical path.

According to a second aspect of the present invention, there is provided an optical scanning device, comprising the optical scanning module according to the first aspect, the single light source, such as a semiconductor laser, a solid state laser, a fiber laser with a semiconductor or a fiber amplifier, a beam splitter, a detector, such as an avalanche photodiode or a single photon avalanche detector, a band pass filter and a lens.

According to a third aspect of the present invention, there is provided a vehicle comprising the optical scanning module according to the first aspect. The vehicle may be a car, a motorcycle, train or an airplane.

### BRIEF DESCRIPTION OF THE DRAWINGS

FIG. 1 illustrates an example of a scanning arrangement in accordance with at least some embodiments of the present invention;

FIG. 2 illustrates another example of the scanning arrangement in accordance with at least some embodiments of the present invention;

FIG. 3 illustrates an example of 3D scanning in accordance with at least some embodiments of the present invention;

FIG. 4 illustrates a first example of a scanning module in accordance with at least some embodiments of the present invention;

FIG. 5 illustrates a second example of a scanning module in accordance with at least some embodiments of the present invention;

FIG. 6A illustrates a first example of operation of a scanning module in accordance with at least some embodiments of the present invention;

FIG. 6B illustrates a second example of operation of a scanning module in accordance with at least some embodiments of the present invention;

FIG. 7 illustrates an example of spot locations in accordance with at least some embodiments of the present invention;

FIG. 8 illustrates a third example of a scanning module in accordance with at least some embodiments of the present invention.

### EMBODIMENTS

Embodiments of the present invention relate to an optical scanning module and device. More specifically, embodiments of the present invention provide an optical scanning module and a device which may scan at a long distance with high angular resolution and narrow field, or at a short distance with low angular resolution and wide field. The optical scanning module and device may comprise two telescope objectives, a scanning mirror and at least two static mirrors. The scanning mirror may be arranged to direct an incoming light signal from a light source such that the light signal either goes past a first static mirror to a first telescope objective, to enable scanning at the short distance with low angular resolution and wide field, or to direct the incoming light signal such that the light signal hits the first static mirror. The first static mirror may be arranged to direct the light signal to a second static mirror and the second static mirror may be arranged to direct another light signal to a second telescope objective, to enable scanning at the long distance with high angular resolution and narrow field.

That is, an aperture of the first telescope objective may be different compared to an aperture of the second telescope objective, to scan at different distances with different angular resolutions. Alternatively, or in addition, the scanning mirror may be arranged to scan at different distances with different angular resolutions by directing another light signal to a desired direction such that the light signal does not go through any telescope objective.

Embodiments of the present invention therefore make it possible to divide and remap a Field of View, FoV, of the scanning module and device optically into different segments in the observed FoV, such as a 3D FoV. The segments scanned by the first and second telescope objectives may also have different widths by utilizing optimal aperture scaling for different segments.

Embodiments of the present invention may be exploited together with Time of Flight, ToF, sensor technology, e.g., for vehicles, such as cars, motorcycles, trains and airplanes. For instance, embodiments of the present invention may be exploited in the automotive industry, where the optical scanning module and device may be used to detect any objects relevant for driving a vehicle, like an autonomous car. In any case, embodiments of the present invention may be used in general in any applications, wherein it is desirable to use an optical scanning module and device that can scan at long distance with high angular resolution and narrow field, and at short distance with low angular resolution and wide field.

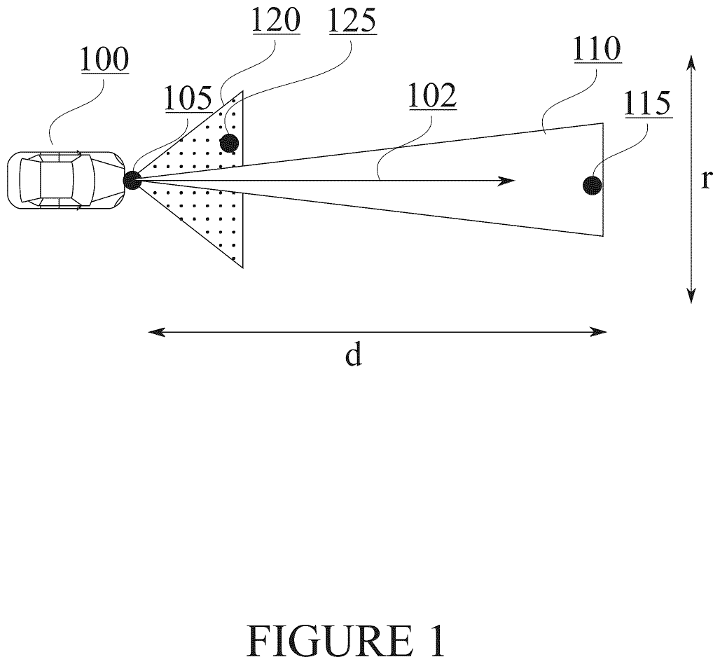

FIG. 1 illustrates an example of a scanning arrangement in accordance with at least some embodiments of the present invention. In FIG. 1, vehicle 100 is shown. Vehicle 100 may be for example a car, a truck, a motorcycle, an airplane, a train, a ship or any suitable, moving vehicle. For instance, vehicle 100 may be an autonomous car. By autonomous car, it is herein meant a car that is at least in part autonomously driving, or one which provides driving advice to a human driver concerning, for example, targets ahead.

Direction of movement of vehicle 100 is denoted by arrow 102. Direction of movement 102 may be referred to as a desired scanning direction. However, it should be noted that in some embodiments the desired scanning direction may be a different direction than direction of movement. Angular range, i.e., width of the FoV of scanning device 105, is denoted by r while distance from scanning device 105 is denoted by d. Scanning device 105 may be attached, or attachable, to vehicle 100.

Even though vehicle 100 is used as an example in the example scanning arrangement of FIG. 1, embodiments of the present invention may be exploited also in static systems, such as in systems monitoring traffic or movement in outdoors or indoors. In addition, embodiments of the present invention may be exploited in various machines, such as machines applied for forest and/or mining industry. Hence, the desired scanning direction may depend on the application in question.

Vehicle 100 may comprise scanning device 105. Alternatively, scanning device 105 may be attached to vehicle 100 by some attaching means, such as screws, bolts, etc. Scanning device 105 may be arranged to scan two segments, i.e., to scan at different distances with different resolutions and widths. That is, scanning device 105 may be arranged for example to scan long distance segment 110 with high angular resolution and narrow field at long distance and to scan wide field segment 120 with low angular resolution and wide field at short distance. Scanning device 105 may for example scan first target 115 within long distance segment 110 and second target 125 within wide field segment 120. Target 115 and/or 125 may be any kind of target. Target 115 and/or 125 may be for example a moving target, such as a human or an animal, or a static target, such as a rock or a building.

In some embodiments, ToF measurements, such as Light Detection and Ranging, LIDAR, measurements, may be exploited. Said ToF measurements may use the finite speed of light to detect targets, such as targets 115 and 125, and their distances from scanning device 105. In a ToF measurement, scanning device 105 may transmit pulses of light towards the target to be detected and then receive/detect reflected versions of the transmitted light pulses. Scanning device 105 may measure the time between the transmission of the light pulses and reception of the reflected versions of the transmitted light pulses. That is, scanning device 105 may measure the time it took for the round trip of the transmitted light pulses. Since the speed of light in air is approximately the same as the speed of light in vacuum, scanning device 105 may determine distances of the objects from the time measurement. Thus, scanning device 105 may be referred to as a ToF sensor as well.

Scanning device 105 may be arranged to detect at least most of the targets close to vehicle 100, such as target 125. Moreover, at least in the case of fast moving vehicles it would be also beneficial to detect also targets further away from vehicle 100, for example target 115 in front of vehicle 100. To detect far away targets, scanning with high angular resolution at long distances is required while targets close to vehicle with could be detected with low angular resolution but with wide field.

Target detection in difficult environmental conditions, such as snow or bright sunlight, is another challenge at least for scanning devices of automotive vehicles. Embodiments of the present invention make it possible to use a larger aperture so that signals reflected from targets further away can be detected, thereby enabling differentiation of signals in circumstances wherein there is more noise.

Moreover, an irradiance of scanning device 105 may be smaller with a larger aperture and hence, light may be spread over a wider area. Therefore, for example a snow flake close by may light up weakly. A smaller solid angle may also be used in light collection, which reduces the amount of diffused light. On the other hand, a larger radius may also illuminate a larger number of snowflakes. So a bigger aperture widening may result in less unwanted stray light from nearby targets.

Embodiments of the present invention therefore enable detecting targets at different distances with different angular resolutions and angular ranges, wherein an angular range may refer to a width of a scanned segment, such as segment 110 or segment 120. If scanning is performed by scanning simultaneously long range and wide field, the cost and size of scanning device are typically high. There is therefore a need to provide a compact scanning device 105 which is suitable for mass production.

As an example, embodiments of the present invention enable 3D LIDAR scanning using an eye-safe 1.5 m wavelength, ToF functionality of Single-Photon Avalanche Diode, SPAD, detectors as well as, Microelectromechanical Systems, MEMS, mirror based scanning to ensure the 3D mapping in any weather together with the small size and low cost estimate provided by the MEMS technology. More specifically, at least some embodiments of the present invention address challenges rising for example from the discrepancy of the SPAD detector and MEMS scanning mirror functionalities, and provide a 3D scanner enabling the mapping of both near and far field objects, such as targets 125 and 115, respectively. For instance, scanning device 105 may comprise a small scanning mirror, such as a MEMS mirror, which redirects, e.g., 1550 nm light pulses. Such pulses may go through special optics to produce two overlapping field segments, like segments 110 and 120, thereby allowing scanning device 105 to scan a narrow field FoV far from scanning device 105 and a wide FoV near to scanning device 105, respectively.

In case of imaging optics, a product (NA*d) of a numerical aperture (NA) and beam diameter (d) is invariant. The photon collection efficiency of scanning device 105 is proportional to dS², wherein dS is an exit pupil diameter of scanning device 105. The exit pupil diameter of scanning device 105 may be referred to as an aperture of scanning device 105 as well. Moreover, the photon collection efficiency of scanning device 105 is proportional to 1/d², wherein d is a maximum detection distance. Therefore, the scanning distance of scanning device 105 may be increased by a factor of X by increasing the aperture of scanning device 150 by the factor of X.

That is, a light beam emitting from scanning device 105 may be optimized in two mutually exclusive ways. For example, the light beam of scanning device 105 may be optimized to have high angular resolution and long scan distance, as in case of long distance segment 110 of FIG. 1, by expanding the aperture of scanning device 105 with the factor of X. However, this leads to decrease in the angular range of scanning device 105 by a factor of 1/X. Alternatively, the angular range of scanning device 105 may be maximized by the factor of X but this leads to decrease in maximum scanning distance and angular resolution of scanning device 105 by the factor of 1/X. In embodiments of the present invention, the angular range of scanning device 105 may be therefore split to at least two segments, such as long distance segment 110 and wide field segment 120. Said segments may be separately optimized to accommodate different requirements per different fields for different applications in terms of maximum range, angular range and angular resolution.

In general, a scan field produced by scanning device 105 may be first divided to some number N of segments, wherein N>=2, and aperture scaling with for example factor Xn, wherein n=1, 2, . . . , N, may be applied to at least one of said segments. The resulting N beams may be oriented to scan their respective fields in a surrounding space, such as in 3D space, and their diameters may be optimally scaled by Xn to meet specifications of each field in the surrounding space. That is, there may be more than two segments, even though only two segments 110 and 120 are shown in FIG. 1.

In some embodiments, simultaneous scanning in vertical and horizontal directions may be performed using one 2-axis scanner or two scanners connected with a suitable relay optics, like an ellipsoid or spherical mirror. An input beam may be composed of one transceiver beam forming one measurement spot in a target space or there may be multiple transceiver beams connected to respective spots in the target space. Alternatively, several spots, arranged along a line or square etc., in the target space, may be illuminated with one laser beam.

There is often a need to scan with high angular resolution and long range in the direction of the movement 102 of vehicle 100, such as an autonomous vehicle. On the other hand, on both sides of the direction of the movement 102 there is a need to scan with a wide angular field but there is no need to scan with high angular resolution and/or long distances. Embodiments of the present invention therefore enable scanning at long distance with high angular resolution and narrow field, and at short distance with low angular resolution and wide field.

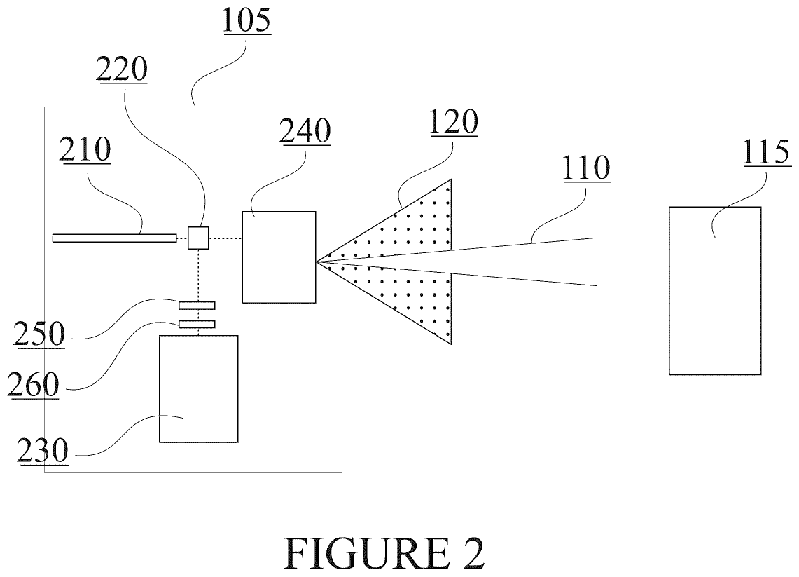

FIG. 2 illustrates another example of the scanning arrangement in accordance with at least some embodiments of the present invention. FIG. 2 illustrates scanning device 105, long distance segment 110, wide field segment 120 and target 115 of FIG. 1. As shown in FIG. 2, scanning device 105 may further comprise light source 210, beam splitter 220, photon detector 230, scanning module 240, band pass filter 250 and lens 260. In some embodiments, scanning device 105 may be referred to as a LIDAR system. Light source 210 may be a laser for example. Light source 210 may be for example a semiconductor laser, solid state laser, or fiber laser with semiconductor or fiber amplifiers. The wavelengths of the lasers may be transformed with nonlinear processes. Photon detector 230 may be for example Avalanche Photodiodes, APD, or SPAD.

Light source 210, beam splitter 220 and photon detector 230 may form a ToF distance sensor, which interfaces with scanning module 240. Scanning module 240 may be arranged to redirect light pulses incoming from the ToF sensor to different directions and at the same time reshape the light pulse incoming from light source 210 with aperture expanding optics. For instance, scanning module 240 may produce two FoVs for two purposes, a long distance FoV with narrow angle, like segment 110, and a short distance FoV with wide angle, like segment 120. These two FoVs may be used to solve the inherent tradeoff arising from the use of aperture expanding optics, which is that with larger magnification ratio a high angular resolution and aperture can be achieved, but at the expense of narrower FoV.

Light source 210 may be arranged to transmit a collimated light pulse through beam splitter 220 to scanning module 240. Scanning module 240 may further direct the collimated light pulse towards target 115. Depending on a position of a scanning mirror of scanning module 240, the collimated light pulse may go through a first telescope objective of scanning module 240, the first telescope objective providing wide angle and short range, like segment 120 in FIG. 1. Alternatively, the collimated light pulse may go through a second telescope objective of scanning module 240, the second telescope objective providing narrow angle and long range, like segment 110 in FIG. 1.

The collimated light pulse transmitted by light source 210 may be reflected from target 115 back to scanning module 240. The reflected collimated light pulse may return via the same telescope objective and be collected with beam splitter 220 and photon detector 230. That is, if the collimated light pulse is transmitted via the second telescope objective providing narrow angle and long range, the reflected version of the transmitted collimated light pulse may return from target 115 of FIG. 1 via the second telescope objective as well. Similarly, if the collimated light pulse is transmitted via the first telescope objective providing wide angle and short range, the reflected version of the transmitted collimated light pulse may return from target 125 via the first telescope objective.

Band pass filter 250 may be arranged to reduce background radiation entering photon detector 230, and lens 260 may be used to focus the light pulse coming from beam splitter 220 to an active area of photon detector 230.

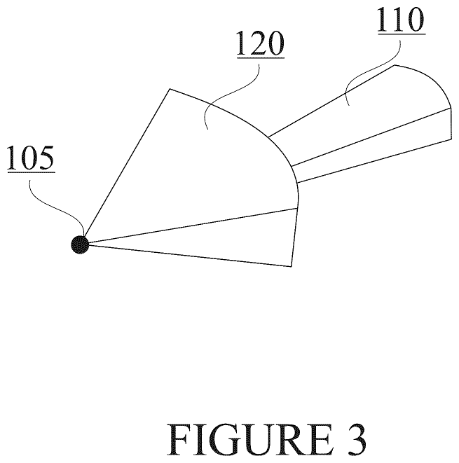

FIG. 3 illustrates an example of 3D scanning in accordance with at least some embodiments of the present invention. FIG. 3 shows a location of scanning device 105 along with segments 110 and 120 of FIG. 1. Even though FIG. 3 shows a 3D visualization of scan segments 110 and 120, embodiments of the present invention may be naturally applied for 2D scanning as well.

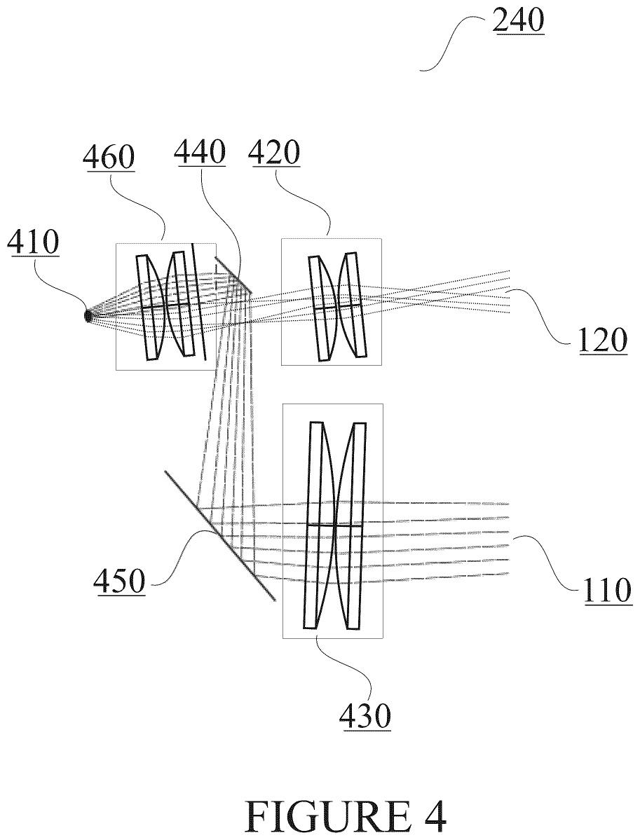

FIG. 4 illustrates a first example of a scanning module in accordance with at least some embodiments of the present invention. More specifically, FIG. 4 illustrates scanning module 240 of FIG. 2. As shown in FIG. 4, scanning module 240 may comprise scanning mirror 410. Scanning mirror 410 may be a MEMS mirror or a gimbal mirror for example. Scanning mirror 410 may be arranged to direct a first light signal, or a pulse, to first telescope objective 420 and a second light signal, or pulse, to second telescope objective 430. First and second telescope objectives 420, 430 may comprise multiple lenses. That is, first and second telescope objectives 420, 430 may be lens packages and comprise multiple lenses. Scanning mirror 410 may be arranged to generate angular scanning fields for first telescope objective 420 and second telescope objective 430.

Scanning module 240 may also comprise first static mirror 440 and second static mirror 450. Hence, scanning mirror 410 may be arranged to direct the first light signal directly to first telescope objective 420 past first static mirror 440 and the second light signal to second telescope objective 430 via first static mirror 440 and second static mirror 450. First static mirror 440 may be tilted such that the second light signal is directed by first static mirror 440 to second static mirror 450 and second static mirror 450 may be tilted such that the second light signal is further directed to second telescope objective 430.

Optical scanning module 240 may be further arranged to receive a reflected version of the first light signal via first telescope objective 420 and a reflected version of the second light signal via the second telescope objective 430. That is, the reflected version of the first light signal may be directed past first static mirror 440 while the reflected version of the second light signal may be received via first static mirror 440 and second static mirror 450. First static mirror 440 may hence be a field splitting mirror.

An aperture of first telescope objective 420 may be different compared to an aperture of second telescope objective 430 to scan at different distances with different angular resolutions and widths. For instance, the aperture of first telescope objective 420 may be smaller than the aperture of second telescope objective 430 to scan targets at short distance with a low angular resolution and wide field using first telescope objective 420 and to scan targets at long distance with a high angular resolution and narrow field using second telescope objective 430. That is, an angular range of first telescope objective 420 may be larger than an angular range of second telescope objective 430.

In some embodiments, there may be more than one second telescope objective 420, i.e., embodiments of the present invention are not limited to providing two segments, like segment 110 and segment 120. For instance, there may be another first static mirror which may direct light signals to another second static mirror, and said another second static mirror may further direct such light signals to another second telescope objective which has a different aperture compared to the aperture of first telescope objective 420 and the aperture of second telescope objective 430.

In some embodiments, scanning module may comprise image lens package 460 between scanning mirror 410 and first static mirror 440, wherein image lens package 460 is arranged to collimate or focus light signals directed by scanning mirror 410 to first static mirror 440 or vice versa. First telescope objective 420 and image lens package 460 may form one telescope while second telescope objective 430 and image lens package 460 may form another telescope. For instance, first telescope objective 420 and image lens package 460 may for example form a 1× magnifying telescope while second telescope objective 430 and image lens package 460 may form a 4.3× magnifying telescope.

First static mirror 440 may placed so that its FoV slicing edge is close to a focal plane of third image lens package 460. That is, first static mirror 440 may be placed such that a central point of first static mirror 440 is misaligned compared to a central point of third image lens package 460. Hence, individual pulses of light have a very small diameter when they are close to the edge of first static mirror 440, which ensures that most of the light pulses are either reflected by first static mirror 440 fully or not at all. This is particularly beneficial because if a light pulse goes through both of the paths, first telescope objective 420 and second telescope objective 430, it cannot be determined from which direction any reflected photons are, thereby making the light pulse unusable and detection of reflected signals impossible.

First telescope objective 420 and second telescope objective 430 may be decentered to minimize optical aberrations. For instance, first telescope objective 420 may be decentered in such a way that it does not form a rotationally symmetric system with image lens package 460. Similarly, second telescope objective 430 may be decentered in such a way that if a light ray exits image lens package 460 along the symmetry axis of image lens package 460, then reflects from first static mirror 440 and then reflects from second static mirror 450, the light ray does not hit the center of second telescope objective 430. This decentering may considerably reduce optical aberrations.

Scanning module 240 may be arranged to compensate a defocus of first telescope objective 420 and/or second telescope objective 430. For instance, first telescope objective 420 and/or second telescope objective 430 may be moved along optical axis to compensate the defocus of the respective telescopes/optical paths. Scanning module 240 may comprise focus compensators (not shown in FIG. 4) for moving first telescope objective 420 and/or second telescope objective 430 and such focus compensators may also compensate for potential MEMS mirror curvature to some extent. Said focus compensation may be achieved by changing the position of first telescope objective 420 and second telescope objective 430, e.g., first telescope objective 420 may be moved further away from image lens package 460 which works as focus compensation for a 1× magnifying telescope.

Different scanner mirrors 410 may be used in scanning module 240. Scanning mirror 410 may be, e.g., a MEMS mirror. A MEMS mirror has the benefit that it can be mass produced and also a small form factor is possible. For instance, a 2D resonant scanning MEMS mirror may be used with around 3 mm optical aperture and 1 kHz scanning frequency. Alternatively, scanning mirror 420 may be a gimbal mirror, such as a non-resonant gimbal mirror, to allow more flexible testing of scanner module 240. As a non-resonant mirror, the gimbal mirror allows “point and shoot” type operation where the measurements may be consistently repeated for a specific angle multiple times.

In the first example of scanning module 240, illustrated in FIG. 4, a first optical path may comprise image lens package 460. Image lens package 460 is optional in all embodiments though. A second optical path may comprise first static mirror 440 and second static mirror 450. Thus, the scanning mirror 410 may be arranged to direct a first light signal coming from single light source 210 to first telescope objective 410 via the first optical path, i.e., image lens package 460. The scanning mirror 410 may be further arranged to direct a second light signal coming from single light source 210 to the second optical path, i.e., to first static mirror 440 and second static mirror 450, to scan at different distances with different angular resolutions in the desired direction, wherein the first optical path is different than the second optical path.

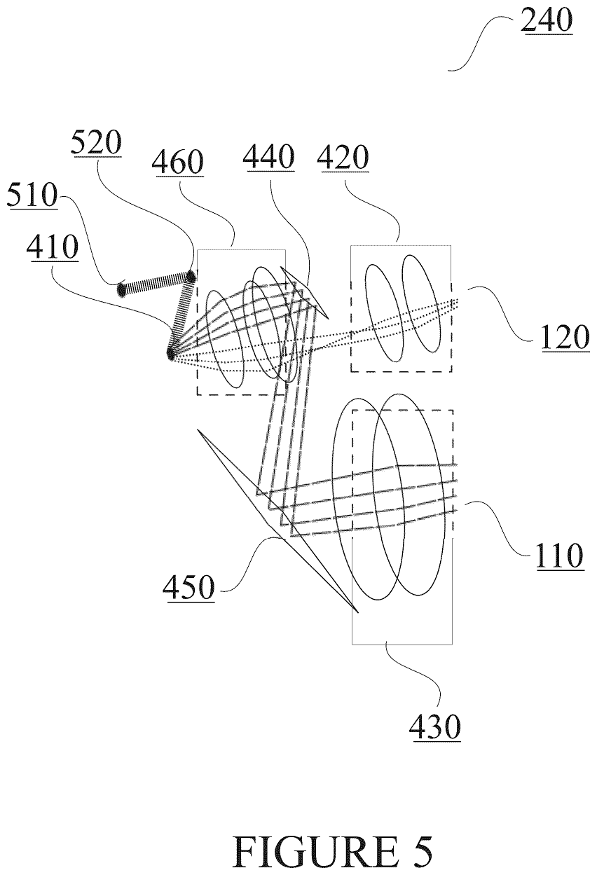

FIG. 5 illustrates a second example of a scanning module in accordance with at least some embodiments of the present invention. Compared to FIG. 4, FIG. 5 additionally shows interface 510 and third, directing static mirror 520 which are incorporated into scanning module 240. Interface 510 may couple scanning module 240 to light source 210 and detector 230 shown in FIG. 2. That is, interface 510 may couple scanning module 240 to a ToF distance sensor for example.

In some embodiments, an incidence angle from third static mirror 520 to scanner mirror 410 may be minimized. This is important in order to achieve maximum aperture size and low optical aberrations. Since a small diameter of scanning mirror 410, such as the small diameter of the MEMS mirror, may be limiting an aperture of optical arrangement 105, scanning mirror 410 should be tilted as little as possible in order to not make the aperture even smaller. More importantly, if the incident light signals come to scanning mirror 410 in a large angle, and there is some curvature on scanning mirror 410, then optical aberrations are introduced to the system in such a way that it is impossible or at least very difficult to compensate for such aberrations fully. The angle of incidence of light rays reflected by third static mirror 520 and incident upon scanning mirror 410 is minimized.

In the second example of scanning module 240, illustrated in FIG. 5, a first optical path may also comprise image lens package 460 and a second optical path may comprise first static mirror 440 and second static mirror 450.

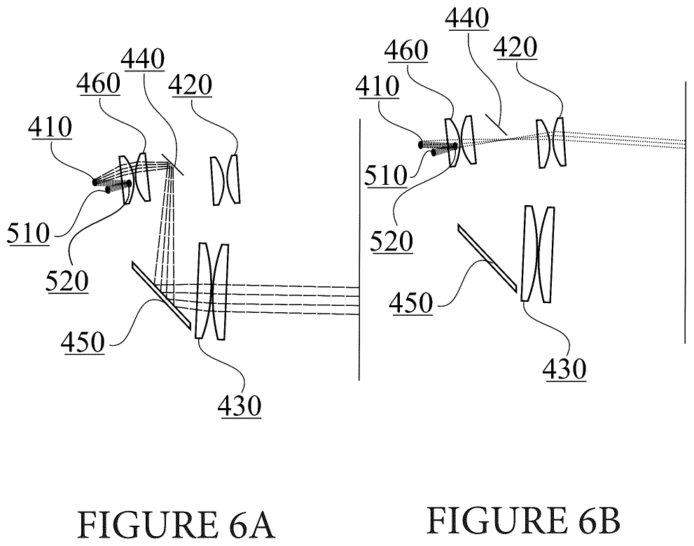

FIG. 6A illustrates a first example of operation of a scanning module in accordance with at least some embodiments of the present invention and FIG. 6B illustrates a second example of operation of a scanning module in accordance with at least some embodiments of the present invention. As shown in FIG. 6A, the second light signal may be directed through second telescope objective 430 and the first light signal may be directed through first telescope objective 420 as shown in FIG. 6B. That is, the first and the second light signals may not be transmitted simultaneously via different paths. Instead, the first and the second signals may be transmitted at different times to enable detection of the corresponding reflected signals. The first light signal may thus go through a first optical path, wherein the first optical path comprises first telescope objective 420 and image lens package 460. Similarly, the second light signal may go through a second optical path, wherein the second optical path comprises second telescope objective 430 and image lens package 460. In general, telescopes may also be referred to as beam expanders.

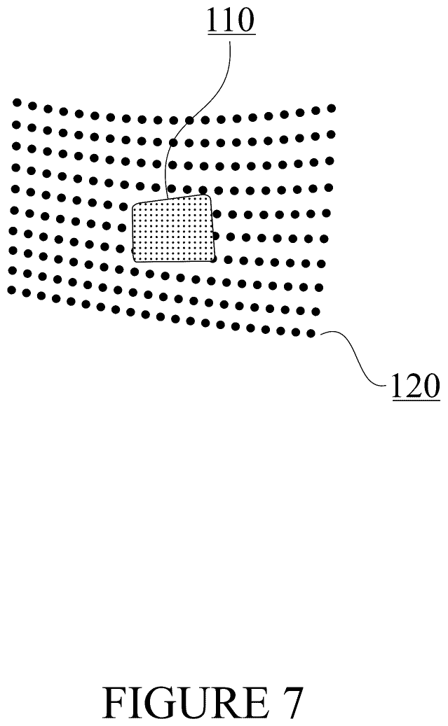

FIG. 7 illustrates an example of spot locations in accordance with at least some embodiments of the present invention. FIG. 7 shows spot locations in a scene when scanner mirror 410 is tilted in in both, x and y direction, i.e., in horizontal and vertical directions. The FoV:s produced by short range optics, such first telescope objective 420, and narrow angle optics, such as second telescope objective 430, are shown to overlap, with the long range optics producing a denser sampling in the middle.

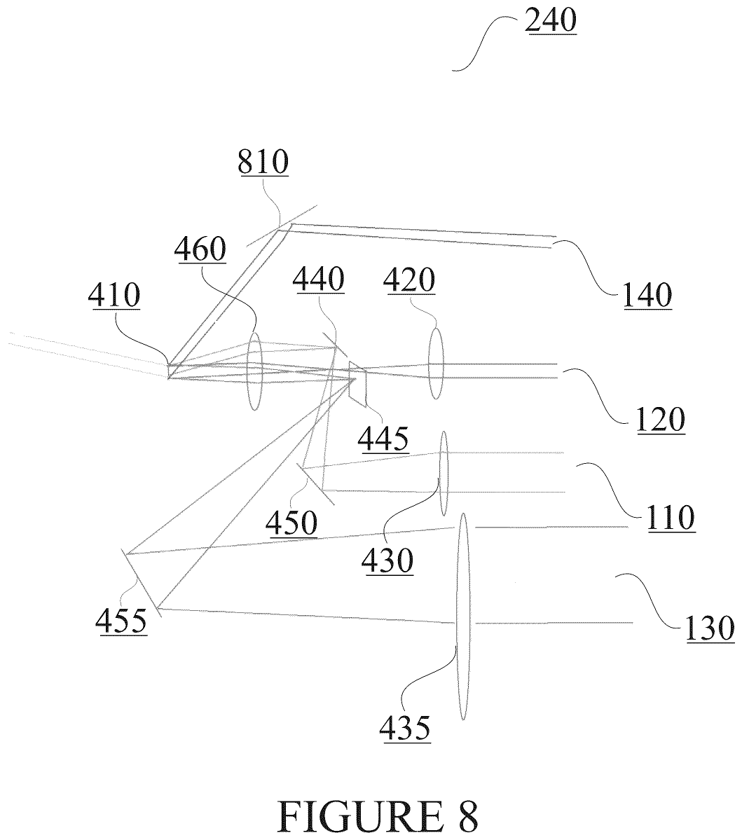

FIG. 8 illustrates a third example of a scanning module in accordance with at least some embodiments of the present invention. As shown in FIG. 8, scanning module 240 may comprise more than one second telescope objective 430, i.e., embodiments of the present invention are not limited to providing two segments, like segment 110 and segment 120.

For instance, there may be another first static mirror 445 which may direct light signals to another second static mirror 455, and another second static mirror 455 may further direct such light signals to another second telescope objective 435 which has a different aperture compared to the aperture of first telescope objective 420 and the aperture of second telescope objective 430, to scan segment 130. Another second telescope objective 435 may be referred to as a third telescope objective. For instance, first telescope objective 420 may provide 1× expansion, second telescope objective 430 may provide 2× expansion and third telescope objective 435 may provide 4× expansion. In addition, in some embodiments, scanning module 240 may comprise a fourth telescope objective with a similar arrangement, or even more telescope objectives.

Alternatively, or in addition, an unexpanded, raw beam from scanning mirror 410 may be used to scan for example segment 140. In such a case, scanning module 240 may comprise static mirror 810 and scanning mirror 410 may be arranged to direct the second light signal to a same direction as first telescope objective 420 via static mirror 810. That is, scanning mirror 810 may be arranged to direct the second light signal to the desired direction such that the second light signal does not go through any telescope objective. Optical scanning module 240 may be further arranged to receive a reflected version of the second light signal via static mirror 810.

That is, in some embodiments, the unexpanded raw beam may be used together with first telescope 420 to scan at different distances with different angular resolutions. The unexpanded raw beam may be used instead of, or in addition to, telescope objectives 430 and/or 435. In general, the telescopes may be Kepler telescopes.

In the third example of scanning module 240, illustrated in FIG. 8, a first optical path may also comprise image lens package 460. At least one second optical path may comprise static mirror 810. Alternatively, or in addition, the at least one second optical path may comprise first static mirror 440 and second static mirror 450. Alternatively, or in addition, the at least one second optical path may comprise another first static mirror 445 and another second static mirror 455, and possibly image lens package 460 as well.

Static mirror 810 is optional. If it is desirable to direct different field segments to the same desired direction, either of the first or the second light signal may be directed to the desired direction, e.g., with a plane mirror. For instance, there may be a plane mirror after first telescope objective 420, to direct the first light signal to the same direction as the second light signal. In such a case, static mirror 810 would not be necessary, but could be there, if so desired. In some embodiments, a direction changing plane mirror may be on the second optical path, like mirror 450 that may be in between third telescope objective 460 and second telescope objective 430.

As an example, if the at least one second optical path comprises two paths to generate scanning segments 110 and 130, scanning module 240 may need to comprise scanning mirror 410, and static mirrors 440 and 445. If the function of said other mirrors is to redirect the light signals and enable smaller package, there are more options for placing said other mirrors.

In some embodiments, some static mirrors may be arranged to fold the first and the second optical paths and redirect the first and the second light signal to scan overlapping segments or scan completely disjoint regions of space.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths and widths as electrical dimensions (i.e., as a function of a used wavelength), shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in vehicles, cars, motorcycles, trains or airplanes in general.

### Acronyms List

APD Avalanche Photodiodes
FoV Field of View
LIDAR Light Detection and Ranging
MEMS Microelectromechanical Systems
SPAD Single-Photon Avalanche Diode
ToF Time of Flight

### REFERENCE SIGNS LIST

REFERENCE SIGNS LIST

| | |
|---|---|
| 100 | Vehicle |
| 102 | Desired scanning direction (e.g., direction of |
| | movement) |
| 105 | Scanning device |
| 110, 120, 130, 140 | Scanning segments |
| 115, 125 | Targets |
| 210 | Light source |
| 220 | Beam splitter |
| 230 | Photon detector |
| 240 | Scanning module |
| 250 | Band pass filter |
| 260 | Lens |
| 410 | Scanning mirror |
| 420, 430, 435 | Telescope objectives |
| 440, 445, 450, 455, | Static mirrors |
| 520, 810 | |
| 460 | Image lens package |
| 510 | Interface |

1. An optical scanning module, comprising:
a scanning mirror, wherein the scanning mirror is arranged to direct a first light signal coming from a single light source to a first telescope objective via a first optical path, and at least one second light signal coming from the single light source to at least one second optical path, to scan at different distances with different angular resolutions, wherein the first optical path is different than the second optical path; and
the optical scanning module is arranged to receive a reflected version of the first light signal via the first telescope objective and the first optical path, and a reflected version of the at least one second light signal via the at least one second optical path.

2. The optical scanning module according to claim 1, wherein the scanning mirror is arranged to direct the first light signal to the first telescope objective via the first optical path and the at least one second light signal to the at least one second optical path, to scan in a desired direction.

3. The optical scanning module according to claim 1, wherein the at least one second optical path further comprises:
a mirror arranged to direct at least one of the at least one second light signal to the desired direction such that said at least one of the at least one second light signal does not go through any telescope objective.

4. The optical scanning module according to claim 1, wherein the at least one second optical path further comprises:
a first static mirror, wherein the first static mirror is a field splitting mirror and the scanning mirror is arranged to direct at least one of the at least one second light signal coming from the single light source to a second telescope objective via the first static mirror, and preferably a second static mirror, wherein an aperture of the first telescope objective is different than an aperture of the second telescope objective to scan at different distances with different angular resolutions in a desired direction; and
the optical scanning module is arranged to receive a reflected version of said at least one of the at least one second light signal via the second telescope objective.

5. The optical scanning module according to claim 4, wherein the scanning mirror is arranged to generate angular scanning fields for the first telescope objective and the second telescope objective.

6. The optical scanning module according to claim 4, wherein the first static mirror is tilted such that said at least one of the at least one second light signal is directed by the first static mirror to the second static mirror and the second static mirror is tilted such that the second light signal is further directed to the second telescope objective.

7. The optical scanning module according to claim 4, further comprising:
an image lens package between the scanning mirror and the first static mirror, wherein the image lens package is arranged to collimate and/or focus light signals directed by the scanning mirror to the first static mirror or vice versa.

8. The optical scanning module according to claim 4, wherein the aperture of the first telescope objective is smaller than the aperture of the second telescope objective to scan at a short distance with a low angular resolution using the first telescope objective and to scan at a long distance with a high angular resolution using the second telescope objective.

9. The optical scanning module according to claim 4, wherein an angular range of the first telescope objective is larger than an angular range of the second telescope objective.

10. The optical scanning module according to claim 4, wherein the first telescope objective and the second telescope objective are directed to a same direction such that a field of view of the second telescope objective is within a field of view of the first telescope objective.

11. The optical scanning module according to claim 4, wherein the first telescope objective and the second telescope objective are decentered to minimize optical aberrations.

12. The optical scanning module according to claim 4, wherein the scanning module is arranged to compensate a defocus of the first telescope objective and/or the second telescope objective by moving lenses of the first telescope objective and/or lenses of the second telescope objective with respect to each other.

13. The optical scanning module according to claim 4, further comprising:
another first static mirror, wherein said another first static mirror is a field splitting mirror and the scanning mirror is arranged to direct at least one third light signal coming from the single light source to a third telescope objective via said another first static mirror and, preferably another second static mirror, wherein an aperture of the third telescope objective is different than an aperture of the first and the second telescope objective to scan at different distances with different angular resolutions; and
the optical scanning module is arranged to receive the reflected version of the at least one third light signal via the third telescope objective.

14. The optical scanning module according to claim 1, wherein the scanning module comprises the first telescope objective.

15. The optical scanning module according to claim 1, further comprising:
static mirrors arranged to fold the first and the second optical paths and redirect the first and the at least one second light signal to scan overlapping segments or scan completely disjoint regions of space.

16. The optical scanning module according to claim 1, further comprising:
a directing static mirror, wherein the directing static mirror is arranged to direct the first light signal and the at least one second light signal coming from the single light source to the scanning mirror, wherein
the directing static mirror is a third static mirror, and the directing static mirror and the scanning mirror are approximately aligned.

17. The optical scanning module according to claim 1, wherein the scanning mirror is a Microelectromechanical Systems, MEMS, mirror, a gimbal mirror, or a transparent beam steering device or other two-axis scanning system.

18. An optical scanning device, comprising:
the optical scanning module according to claim 1;
a single light source, such as a semiconductor laser, a solid state laser, a fiber laser with a semiconductor or a fiber amplifier;
a beam splitter;
a detector, such as an avalanche photodiode or a single photon avalanche detector;
a band pass filter; and
a lens.

19. A vehicle comprising the optical scanning module according to claim 1.

20. The optical scanning module according to claim 1, wherein the scanning module comprises a second telescope objective.
